(19) United States
(12) Patent Application Publication
(10) Pub. No.: US 2026/0049902 A1
(43) Pub. Date: Feb. 19, 2026

(54) DETECTION AND LOCALIZATION OF ISSUES IN WORK MACHINES USING ACOUSTIC SENSOR

(71) Applicant: Caterpillar Inc., Peoria, IL (US)

(72) Inventor: Shaun D. CURRIER, Naperville, IL (US)

(73) Assignee: Caterpillar Inc., Peoria, IL (US)

(21) Appl. No.: 18/807,836

(22) Filed: Aug. 16, 2024

(51) Int. Cl. G01M 99/00; G10L 25/51

(52) U.S. Cl. CPC G01M 99/005; G10L 25/51

(57) ABSTRACT

Problems with a work machine that manifest themselves as noises may go unnoticed in the case of remote or autonomous operation of the work machine. Accordingly, disclosed embodiments utilize acoustic sensor(s), mounted on the work machine, to monitor noises emanating from different locations on the work machine, corresponding to known components. Spatial filtering may be used to map noises to specific components, and acoustic filtering may be used to identify noises that indicate problems or other issues with those components. When an issue is detected, an action, such as notifying an operator or autonomous control system, may be initiated to remediate the issue.

### TECHNICAL FIELD

The embodiments described herein are generally directed to the operation of a work machine, and, more particularly, to detecting and locating issues in a work machine using an acoustic sensor, such as a microphone array or acoustic camera.

### BACKGROUND

Many problems that occur during the operation of work machines may initially manifest themselves as noises. For example, a medium-sized wheel loader has at least twenty-two large, load-bearing pin joints. The pin, in such a pin joint, may make a loud noise when there is a problem or when the pin has reached the end of its life. Intervention as soon as a noise is heard can save costs and prevent further problems down the line.

Normally, a local operator in the cabin of a work machine will hear any noise that indicates a problem, and follow that noise to its source in order to locate the problem. However, remotely operated or autonomous work machines do not have a local operator. Thus, such noises are likely to go unnoticed. Moreover, even if there is a local operator, the local operator may not hear the noise (e.g., in a sound-proofed cabin), may not recognize that the noise represents a problem, may not be able to locate the source of the noise, or may not report the noise (e.g., to a supervisor, service technician, etc.).

International Patent Publication No. WO/2011/138488 A1 utilizes a microphone installed on the exterior of the cab of soil-working machinery to capture sounds produced by the machinery during operation, compares the captured sounds to a stored fingerprint representing breakage of a part, and warns the operator when breakage of the part is detected. The present disclosure is directed towards overcoming one or more deficiencies in the state of the art discovered by the inventor.

### SUMMARY

In an embodiment, a method comprises using at least one hardware processor in a work machine to, in real time with operation of the work machine: receive audio data captured by one or more acoustic sensors; apply spatial filtering to the audio data to identify one or more portions of the audio data, each of the one or more portions of the audio data being captured from a different location on the work machine than any other one of the one or more portions of the audio data; and for each of the one or more portions of the audio data, apply acoustic filtering to the portion of the audio data, determine whether or not an issue exists based on the acoustic filtering, and when determining that the issue exists, initiate a remedial action.

In an embodiment, a method comprises using at least one hardware processor in a work machine to, in real time with operation of the work machine: receive audio data captured by a microphone array mounted on a cabin of the work machine; apply spatial filtering to the audio data to identify a plurality of portions of the audio data, each of the plurality of portions of the audio data being captured from a different location on the work machine than any other one of the plurality of portions of the audio data, and each location corresponding to a component of the work machine; and for each of the plurality of portions of the audio data, apply acoustic filtering to the portion of the audio data, determine whether or not an issue exists based on the acoustic filtering, and when determining that the issue exists, output a notification to an operator, the notification identifying the component corresponding to the location from which the portion of the audio data was captured.

In an embodiment, a work machine comprises: a machine body; a work implement; one or more acoustic sensors mounted on the work machine; and a controller configured to, in real time with operation of the work machine, receive audio data captured by the one or more acoustic sensors, apply spatial filtering to the audio data to identify one or more portions of the audio data, each of the one or more portions of the audio data being captured from a different location on the work machine than any other one of the one or more portions of the audio data, and each location corresponding to a component of the work machine, and for each of the one or more portions of the audio data, apply acoustic filtering to the portion of the audio data, determine whether or not an issue exists based on the acoustic filtering, and when determining that the issue exists, output a notification that identifies the component corresponding to the location from which the portion of the audio data was captured.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 illustrates an example work machine, according to an embodiment;

FIG. 2 illustrates a process for detecting and localizing issues in a work machine using an acoustic sensor, according to an embodiment; and

FIG. 3 illustrates an example controller for implementing a process for detecting and localizing issues in a work machine using an acoustic sensor, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details.

In some instances, well-known structures and components are shown in simplified form for brevity of description. For clarity and ease of explanation, some surfaces and details may be omitted in the present description and figures. It should also be understood that the various components illustrated herein are not necessarily drawn to scale. In other words, the features disclosed in various embodiments may be implemented using different relative dimensions within and between components than those illustrated in the drawings.

References herein to “side,” “top,” “bottom,” “front,” “rear,” “above,” “below,” “forward,” “backward,” “left,” “right,” and the like are used for convenience of understanding to convey the relative positions of various components with respect to each other, and do not imply any specific orientation of those components in absolute terms (e.g., with respect to the external environment or the ground). In addition, the terms “respective” and “respectively” signify an association between members of a group of first components and members of a group of second components. For example, the phrase “each component A connected to a respective component B” would signify A1 connected to B1, A2 connected to B2, . . . and AN connected to BN. Also, as used herein, a reference numeral with an appended letter will be used to refer to a specific component, whereas the same reference numeral without any appended letter will be used to refer collectively to a plurality of the component or to refer to a generic or arbitrary instance of the component.

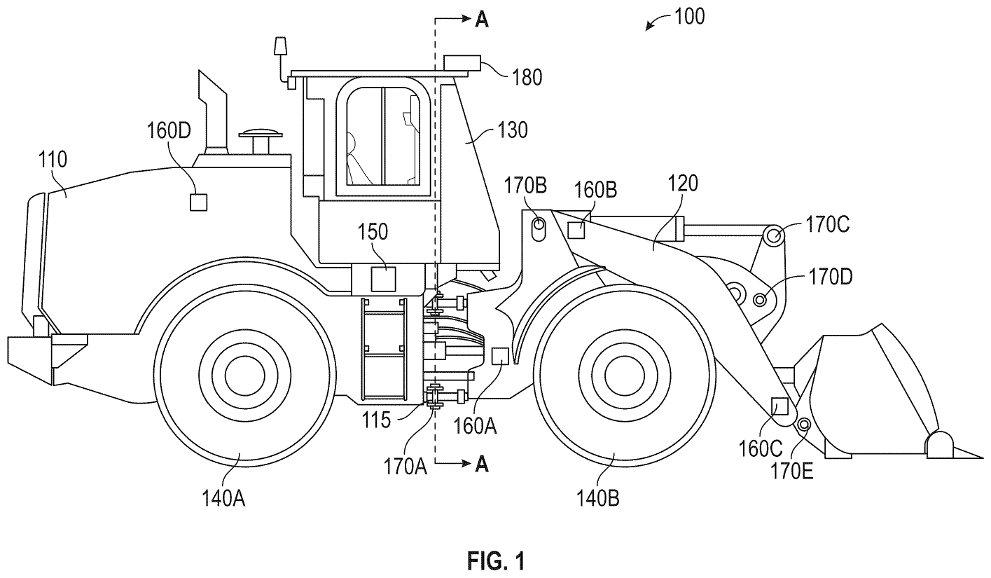

FIG. 1 illustrates an example work machine 100, according to an embodiment. Work machine 100 is illustrated as a wheel loader. However, work machine 100 may be any type of work machine, including a dump truck, asphalt paver, backhoe loader, skid steer, track loader, cold planer, motor grader, compactor, bulldozer, electric rope shovel, forest machine, hydraulic mining shovel, material handler, pipe-layer, road reclaimer, telehandler, tractor-scraper, or the like. Work machine 100 may be operated by a local operator, a remote operator (e.g., via a wireless communication network), and/or autonomously (e.g., semi-autonomously with some human supervision, or fully autonomously without human supervision).

As illustrated, work machine 100 may comprise a machine body 110, a work implement 120, a cabin 130 supported by machine body 110, and one or more ground-engaging members 140. Machine body 110 may comprise an internal combustion engine, electric motor (e.g., driven by a battery pack), or the like. Machine body 110 may be connected to work implement 120 via a linkage 115. Linkage 115 may enable articulation or rotation of work implement 120, relative to machine body 110, around an axis A. This articulation may enable work machine 100 to be steered and/or work implement 120 to be operated at an angle relative to machine body 110.

Work implement 120 is illustrated as a bucket. However, work implement 120 could comprise any apparatus that is capable of performing work under the control of an operator or autonomous control system. Examples of other work implements 120 include, without limitation, a bucket arm, a dump bed, a grader, a planer, a drill, a crane, a forklift, and the like.

Cabin 130 may comprise a seat for the operator, one or more input devices (e.g., joysticks, levers, buttons, pedals, etc.) for controlling work machine 100, a display console (e.g., comprising a touch-panel display), and/or the like. In an embodiment in which work machine 100 is remotely operated and/or autonomous and work machine 100 does not support local operation, cabin 130 may be omitted. Operation of work machine 100 may comprise an operator or autonomous control system accelerating and decelerating (e.g., braking) work machine 100, steering work machine 100, operating work implement 120, and/or the like.

Ground-engaging member(s) 140 are configured to move machine body 110 and/or work implement 120 with respect to the ground. Ground-engaging members 140 are illustrated as wheels, but may comprise other types of components for moving machine body 110 and/or work implement 120 with respect to the ground, such as tracks, rollers, and/or the like. Ground-engaging members 140 may be driven by a drivetrain, which is in turn driven by an internal combustion engine or electric motor within machine body 110. Work machine 100 may comprise ground-engagement members 140A supporting machine body 110 and/or ground-engagement members 140B supporting work implement 120.

Work machine 100 may comprise a controller 150 (e.g., within machine body 110, work implement 120, and/or cabin 130), which may be an electronic control unit (ECU). Controller 115 may be communicatively coupled (e.g., via wired or wireless communications) to input device(s), within cabin 130 or at a remote terminal, and to one or a plurality of subsystems of work machine 110, including one or more actuators (e.g., valves, hydraulic cylinders, etc.) within work implement 120. Controller 150 may receive control inputs from a local operator or remote operator. Alternatively or additionally, controller 150 may comprise or be communicatively coupled to an autonomous control system that automatically generates control inputs. In either case, controller 150 may control one or more of actuators in work machine 100 according to the received control inputs.

Controller 150 may also be communicatively coupled to one or more sensors 160 within work machine 100. While sensors 160 have been illustrated as sensors 160A, 160B, 160C, and 160D, it should be understood that these are provided as arbitrary examples. In reality, sensors 160 may comprise any number of sensors at any of various locations within and around work machine 100. Sensor(s) 160 may include any type of sensor or sensor array capable of measuring values of one or more parameters of one or more subsystems of work machine 100 and/or the external environment of work machine 100. Examples of such parameters include, without limitation, the position of one or more components of work machine 100, engine speed, machine speed, pressure of a fluid (e.g., fuel, oil, coolant, hydraulic fluid, etc.), flow rate of a fluid, temperature of a fluid, contamination level of a fluid, viscosity of a fluid, electric current, electric voltage, state of charge of a battery pack, fluid consumption rates, loading level, transmission output ratio, slip, grade, traction, mileage, ambient temperature, and/or the like. Of particular relevance to certain embodiments, sensor(s) 160 may output one or more operational parameters, representing a position of each of one or more components 170 of work machine 100, such as a valve, hydraulic cylinder, pin joint, pin, and/or the like. Controller 150 may collect these parameters, including these operational parameters, from sensors 160, and process these parameters as described elsewhere herein.

For the purposes of illustration, various components 170 are illustrated, including components 170A, 170B, 170C, 170D, and 170E. In the illustrated example, components 170 comprise a plurality of pins that fix two or more components together in a joint. For example, component 170A is a pin that joins machine body 110 and work implement 120 at linkage 115, component 170B is a pin that joins a bucket arm to a chassis of work implement 120, component 170C is a pin that joins the piston of a hydraulic cylinder to a pivotable component, and so on and so forth. However, it should be understood that component 170 may refer to any arbitrary component of interest in work machine 100, including other types of components besides pins, such as valves, hydraulic cylinders, and/or the like. In particular, a component 170 may be any component which may manifest a problem via sound.

Work machine 100 may comprise one or more acoustic sensors 180 that are configured to capture audio data. Acoustic sensor(s) 180 may comprise a microphone array, an acoustic camera, and/or the like. Acoustic sensor(s) 180 may be mounted on cabin 130 of work machine 100, for example, on the top of cabin 130 of work machine 100. Alternatively or additionally, acoustic sensor(s) 180 may be mounted at another position on work machine 100, such as on machine body 110, within an engine or motor enclosure of machine body 110, on work implement 120, on the front or rear of cabin 130, and/or the like. However, it is generally advantageous for the mounting location of acoustic sensor(s) 180 to be external to portions of work machine 100 that are prone to the collection of dirt and other debris, so as to keep acoustic sensor(s) relatively free of debris that may interfere with the capture of audio data. Acoustic sensor(s) 180 may be positioned and/or oriented to capture noise from a plurality of components 170 of interest at a plurality of locations on work machine 100.

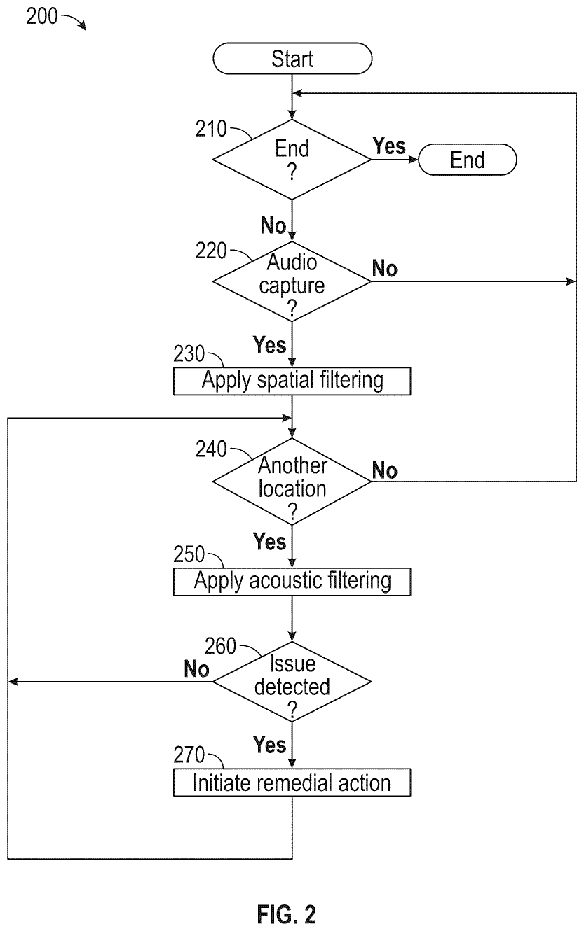

FIG. 2 illustrates a process 200 for detecting and localizing issues in a work machine 100 using an acoustic sensor 180, according to an embodiment. Process 200 may be implemented by controller 150, in real time with operation of work machine 100. As used herein, the term “real time” or “real-time” should be understood to mean events that occur simultaneously, as well as events that are temporally spaced apart due to ordinary latencies in processing, communications, memory access, and/or the like. The term “issue” will generally be used to refer to a problem with a component 170, but should be broadly understood to include both immediate problems, such as a partial or full failure of a component 170, and non-immediate problems, such as a degree of wear of a component 170.

While process 200 is illustrated with a certain arrangement and ordering of subprocesses, process 200 may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

Subprocess 210 may determine whether or not to end process 200. Process 200 may execute continuously, in real time, for as long as work machine 100 is operational (e.g., from the time that work machine 100 is turned on until the time that work machine 100 is shut down). Alternatively or additionally, process 200 may be toggled on and/or off by a local operator (e.g., via an input device within cabin 130), a remote operator (e.g., via an input device at a remote terminal), an autonomous control system, and/or the like. Thus, process 200 may end when work machine 100 is shut down and/or when process 200 is toggled off. When determining to end process 200 (i.e., “Yes” in subprocess 210), process 200 may end. Otherwise, until determining to end process 200 (i.e., “No” in subprocess 210), process 200 may proceed to subprocess 220.

Subprocess 220 may determine whether or not new audio data have been captured by acoustic sensor(s) 180. In an embodiment, audio data may be streamed from acoustic sensor(s) 180, in real time, according to a sampling rate. In this case, subprocess 220 may determine that new audio data have been captured at the end of each time interval defined by the sampling rate. In an alternative embodiment, audio data may be collected only when the noise captured by acoustic sensor(s) 180 satisfies one or more criteria (e.g., exceeds a predefined volume threshold). In this case, subprocess 220 may determine that new audio data have been captured whenever audio data, satisfying these criteria, are collected by acoustic sensor(s) 180. In any case, when determining that new audio data have been captured (i.e., “Yes” in subprocess 220), process 200 may proceed to subprocess 230. Otherwise, when not determining that new audio data have been captured (i.e., “No” in subprocess 220), process 200 may return to subprocess 210.

Subprocess 230 may receive the audio data captured by acoustic sensor(s) 180, and apply spatial filtering to the audio data to identify one or more portions of the audio data that each represents a different location on work machine 100. In a preferred embodiment, the spatial filtering identifies a plurality of portions of the audio data that each represents a different location on work machine 100 than any other one of the plurality of portions of the audio data. Each location, represented by a portion of the audio data, may correspond to a particular component 170 of work machine 100.

The spatial filtering may determine from which direction each portion of the audio data were captured. In this case, each direction may be mapped to a location on work machine 100, based on the position of each component 170, relative to acoustic sensor(s) 180. In the event that one or more components 170 move relative to acoustic sensor(s) 180, or are on another component (e.g., work implement 120) that moves relative to acoustic sensor(s) 180, the component 170 that corresponds to a direction from which a portion of the audio data were captured may be determined based on the relative positions of the components 170, as determined, for example, from positional parameters output by one or more sensors 160. In other words, the spatial filtering may track the kinematic location of one or more components 170 to be monitored based on the output of sensor(s) 160. The spatial filtering may retain audio data, as the portion(s) of audio data, from direction(s) that each intersects with the location of a component 170 being monitored for issues, while filtering out (e.g., canceling out) sound from any other directions. Thus, after the spatial filtering, only portions of the audio data, representing components to be monitored, remain for further processing.

In an embodiment, acoustic sensor(s) 180 comprise a microphone array. A microphone array comprises a plurality of microphones that operate in tandem. The plurality of microphones may comprise omnidirectional microphones and/or directional microphones distributed around the perimeter of the microphone array. The spatial filtering may comprise processing (e.g., by controller 150) the sound signals (i.e., the audio data) captured by the plurality of microphones in the microphone array to localize the source (e.g., component 170) of each of one or more sounds in the audio data.

In an alternative or additional embodiment, acoustic sensor(s) 180 may comprise an acoustic camera. An acoustic camera generally comprises a microphone array and an optical camera. The microphone array may be used, as described above, to capture audio data and localize the source of each of one or more sounds in the audio data, and the optical camera may be used to map the source of each sound to two-dimensional image data captured by the optical camera. In an embodiment that utilizes an acoustic camera, this two-dimensional image data may be provided to a local operator (e.g., on a display within cabin 130) or remote operator (e.g., on a display at a remote terminal) to aid the operator in visually identifying the component 170 to which each portion of the audio data pertains.

In an embodiment, the spatial filtering may comprise varying one or more operating parameters of work machine 100, and using the resulting variation of sound in the audio data to verify which component 170 is the source of the sound. For example, controller 150 may actuate a pump or other device to vary a fluid pressure through a valve, according to a predefined pattern, and determine that, when the sound in the audio data varies according to a similar or corresponding pattern, the valve is the component 170 that is producing the sound. More generally, controller 150 may actuate any component 170 to be monitored or actuate a component that impacts component 170, according to a predefined pattern, and verify that the component 170 is the source of a sound in the audio data when the sound in the audio data varies according to a pattern that corresponds to the predefined pattern. In this case, for the spatial filtering, work machine 100 may be placed in a diagnosis mode, in which operation of work machine 100 is halted, to thereby prevent the operator from affecting the actuation of components 170 during the spatial filtering and vice versa.

Subprocess 240 may iterate through each portion of the audio data identified in subprocess 230. In other words, subprocesses 240-270 may be performed for each of the one or more portions of the audio data, output by the spatial filtering in subprocess 230. When another portion of the audio data, representing another location, remains to be considered (i.e., “Yes” in subprocess 240), process 200 may proceed to subprocess 250. Otherwise, once all portions of the audio data have been processed (i.e., “No” in subprocess 240), process 200 may return to subprocess 210.

Subprocess 250 may apply acoustic filtering to the portion of the audio data currently being processed. The acoustic filtering may transform the audio data, filter out (e.g., cancel out or otherwise exclude) certain sounds from the audio data, enhance certain sounds in the audio data, and/or otherwise manipulate the audio data to enable a determination to be made as to whether or not an issue exists. For example, the acoustic filtering may comprise a bandpass filter that isolates one or more frequency bands in the portion of the audio data currently being processed, while canceling out all other frequency bands in the portion of the audio data currently being processed. As another example, the acoustic filtering may comprise comparing the portion of the audio data, currently being processed, to a reference acoustical pattern, to determine whether or not the reference acoustical pattern exists in the portion of the audio data. As yet another example, the acoustic filtering may comprise determining one or more operational parameters of work machine 100 that are coincident with a time (e.g., at or around the same time) at which the portion of the audio data, currently being processed, was captured, and filtering out noise from the portion of the audio data based on the operational parameter(s). Examples of such operational parameters include, without limitation, engine speed, pump speed, pump displacement, transmission shifting, valve action, tilt actuation, lift actuation, third function valve actuation, fourth function valve actuation, steering actuation, braking, ground speed, and the like.

Subprocess 260 may determine whether or not an issue exists based on the acoustic filtering in subprocess 250. In particular, subprocess 260 may determine whether or not the acoustically filtered portion of the audio data, currently being processed, represents a problem with a component 170 that corresponds to that portion of the audio data, as determined by the spatial filtering in subprocess 230. In other words, subprocess 260 may detect an issue with the corresponding component 170 based on the portion of audio data captured from the location of that component 170. When determining that the issue exists (i.e., “Yes” in subprocess 260), process 200 may proceed to subprocess 270. Otherwise, when not determining that the issue exists (i.e., “No” in subprocess 260), process 200 may return to subprocess 240.

In an embodiment in which the acoustic filtering comprises a bandpass filter, subprocess 260 may comprise determining whether or not an audio characteristic exists within the frequency band(s) output by the bandpass filter. This audio characteristic may comprise the presence of any sound within the frequency band(s), the presence of a reference acoustical pattern within the frequency band(s), a magnitude of sound within the frequency band(s) exceeding a predefined threshold, and/or the like. It should be understood that, in this case, the presence of this audio characteristic, in the frequency band(s) output by the bandpass filter, indicates that the corresponding component 170 is making a sound that indicates a problem with the component 170. Thus, when the audio characteristic exists within the frequency band(s), output by the bandpass filter, subprocess 260 may determine that an issue exists (i.e., “Yes” in subprocess 260). Otherwise, subprocess 260 may determine that no issue exists (i.e., “No” in subprocess 260).

In an embodiment in which the acoustic filtering comprises comparing the portion of the audio data, currently being processed, to a reference acoustical pattern, subprocess 260 may comprise determining whether or not the portion of the audio data matches the reference acoustical pattern. A reference acoustical pattern may comprise a pattern in frequency, volume, pitch, and/or any other audio characteristic. When the reference acoustical pattern exists within the portion of the audio data, as determined by the comparison, subprocess 260 may determine than an issue exists (i.e., “Yes” in subprocess 260). Otherwise, subprocess 260 may determine that no issue exists (i.e., “No” in subprocess 260).

In an embodiment, subprocess 260 may determine whether or not an issue exists based on both the acoustic filtering and whether or not the component 170, corresponding to the source of the portion of audio data currently being processed, was moving at the time that the portion of audio data was captured. For example, subprocess 260 may determine the component 170 of work machine 100 that corresponds to the location on work machine 100 from which the portion of the audio data was captured, determine whether or not the component 170 was moving at a time at which the portion of the audio data was captured based on sensor data from one or more sensors 160 on work machine 100, and determine whether or not the issue exists based on the acoustic filtering and the determination of whether or not the component 170 was moving at the time at which the portion of the audio data was captured. More generally, in this embodiment, subprocess 260 may determine that an issue exists (i.e., “Yes” in subprocess 260) when both the acoustically filtered portion of the audio data indicates that the issue exists (e.g., using any of the acoustic filtering described herein) and the sensor data indicate that the component 170, corresponding to that portion of audio data, was simultaneously in motion or otherwise impacted by simultaneous motion.

Subprocess 270 may initiate a remedial action when subprocess 260 determines that an issue exists, and then return to subprocess 240. The remedial action may comprise outputting a notification of the issue detected in subprocess 260. In the case of a local or remote operator, the notification may be output to a display (e.g., touch-panel display) or other visual indication (e.g., indicator light), haptic device (e.g., within a joystick or other control device), and/or other device within cabin 130 or at a remote terminal, respectively. Alternatively or additionally, the notification may be sent to a supervisor, service technician, or other recipient, to ensure that the issue is not simply ignored by the operator. In the case of autonomous control, the notification may comprise an inter-process message that is sent to the autonomous control system (e.g., within controller 150), to thereby mitigate or replace the loss of the operator's role.

In an embodiment, subprocess 270 comprises determining the component 170 of work machine 100 that corresponds to the location on work machine 100 from which the portion of audio data was captured. In this case, the notification of the remedial action may identify the determined component 170 from which the portion of the audio data was captured. Notably, the component 170 may have already, at least essentially, been identified by the spatial filtering in subprocess 230. In particular, each location that corresponds to a portion of the audio data, output by the spatial filtering, may be pre-mapped and/or mapped based on positional data from sensor(s) 160, to a particular component 170 that is identified in the notification. In an embodiment in which the notification is displayed (e.g., on a display in cabin 130 or at a remote terminal), the visual representation of the notification may comprise a name or other identifier of the component 170, a visual representation (e.g., image, schematic, etc.) of the component 170 in isolation or in the context of work machine 100, for example, as a real-time image or video stream of the component 170 captured by an acoustic camera or other camera, and/or the like.

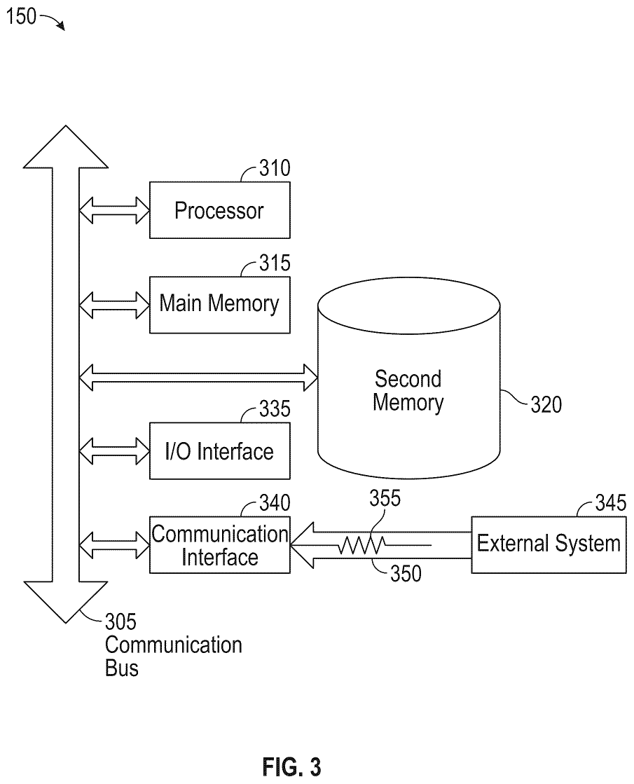

FIG. 3 illustrates an example controller 150 for implementing process 200 for detecting and localizing issues in a work machine 100 using an acoustic sensor 180, according to an embodiment. As mentioned elsewhere herein, controller 150 may comprise or consist of an electronic control unit (ECU) within work machine 100.

Controller 150 may comprise one or more processors 310. Processor(s) 310 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 310. Examples of processors which may be used with controller 150 include, without limitation, any of the processors (e.g., Pentium™, Core i7™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 310 may be connected to a communication bus 305. Communication bus 305 may include a data channel for facilitating information transfer between storage and other peripheral components of controller 150. Furthermore, communication bus 305 may provide a set of signals used for communication with processor 310, including a data bus, address bus, and/or control bus (not shown). Communication bus 305 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

Controller 150 may comprise main memory 315. Main memory 315 provides storage of instructions and/or other data for software executing on processor 310. It should be understood that instructions stored in the memory and executed by processor 310 may be written and/or compiled according to any suitable language, including without limitation C/C++, Java, JavaScript, Perl, Python, Visual Basic, .NET, and the like. Main memory 315 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Controller 150 may comprise secondary memory 320. Secondary memory 320 is a non-transitory computer-readable medium having instructions and/or other data for software stored thereon. In this description, the term “computer-readable medium” is used to refer to any non-transitory computer-readable storage media used to provide computer-executable code and/or other data to or within controller 150. The computer software stored on secondary memory 320 is read into main memory 315 for execution by processor 310. Secondary memory 320 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Controller 150 may comprise an input/output (I/O) interface 335. I/O interface 335 provides an interface between one or more components of controller 150 and one or more input and/or output devices. For example, I/O interface 335 may receive the output of one or more sensors 160, and/or output control signals to one or more subsystems or other components of work machine 100.

Controller 150 may comprise a communication interface 340. Communication interface 340 allows software to be transferred between controller 150 and external devices, networks, or other information sources and/or destinations. For example, instructions and/or other data may be transferred to controller 150, over one or more networks, from a network server via communication interface 340. Examples of communication interface 340 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing controller 150 with a network or another computing device. Communication interface 340 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 340 is generally in the form of electrical communication signals 355. These signals 355 may be provided to communication interface 340 via a communication channel 350 between communication interface 340 and an external system 345. In an embodiment, communication channel 350 may be a wired or wireless network, or any variety of other communication links. Communication channel 350 carries signals 355 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 315 and/or secondary memory 320. Computer-executable code can also be received from an external system 345 via communication interface 340 and stored in main memory 315 and/or secondary memory 320. Such computer-executable code, when executed by processor(s) 310, may enable controller 150 to perform the various functions of the disclosed embodiments, including, for example, process 200.

### INDUSTRIAL APPLICABILITY

Many problems that occur during the operation of work machines 100 initially manifest themselves as noises. Normally, a local operator will detect any such noise. However, this is not possible when there is no local operator, for example, in the case of a remotely operated or autonomous work machine 100. In addition, even when there is an operator, the operator may not hear the noise, recognize the noise, be able to locate the source of the noise, or report the noise.

Accordingly, disclosed embodiments utilize one or more acoustic sensors 180, such as a microphone array or acoustic camera, mounted on work machine 100. Controller 150 of work machine 100 may automatically monitor the audio data captured by the acoustic sensor(s) 180, apply spatial filtering to map portions of the audio data to particular components 170, apply acoustic filtering to detect issues with the components 170, and initiate a remedial action, such as notifying an operator, supervisor, and/or autonomous control system, when detecting an issue with a component 170. Thus, disclosed embodiments rectify the situation in which the lack of a local operator and/or the failing of a local operator allows an audible problem with a component 170 of a work machine 100 to go unnoticed. Advantageously, detecting, localizing, and addressing the problem early can prevent further or more severe problems from occurring down the line.

As an example, a medium-sized wheel loader has at least twenty-two large, load-bearing pin joints. If a pin, in one of these pin joints, develops a problem, it will generally begin making a noise. In this case, acoustic sensor(s) 180 will capture the noise in audio data. In subprocess 230, the portion of the audio data, representing this noise, may be localized to the particular pin making the noise, using spatial filtering. Based on the knowledge that this portion of the audio data corresponds to a pin, subprocesses 250 and 260 may determine that the noise, represented by the portion of audio data, is within a frequency range that is characteristic of a problem with the pin, correlates to simultaneous pin joint rotation (e.g., determined from positional measurements output by sensor(s) 160), follows a rotation of the pin as the pin moves through space relative to acoustic sensor(s) 180, and/or the like. In this case, subprocess 270 may notify an operator or autonomous control system of the problem, as well as identify the particular pin and/or the location of the particular pin that is the subject of the problem.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of work machine. Hence, although the present embodiments are, for convenience of explanation, depicted and described as being implemented in a wheel loader, it will be appreciated that it can be implemented in various other types of work machines in which problems or other issues audibly manifest themselves, and in various other systems and environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

What is claimed is:

1. A method comprising using at least one hardware processor in a work machine to, in real time with operation of the work machine:
receive audio data captured by one or more acoustic sensors;
apply spatial filtering to the audio data to identify one or more portions of the audio data, each of the one or more portions of the audio data being captured from a different location on the work machine than any other one of the one or more portions of the audio data; and
for each of the one or more portions of the audio data,
apply acoustic filtering to the portion of the audio data,
determine whether or not an issue exists based on the acoustic filtering, and
when determining that the issue exists, initiate a remedial action.

2. The method of claim 1, wherein the one or more acoustic sensors comprise a microphone array.

3. The method of claim 1, wherein the one or more acoustic sensors comprise an acoustic camera.

4. The method of claim 1, wherein the one or more acoustic sensors are mounted on a cabin of the work machine.

5. The method of claim 1, wherein the acoustic filtering comprises a bandpass filter that isolates one or more frequency bands of the portion of the audio data.

6. The method of claim 5, wherein determining whether or not the issue exists comprises determining whether or not an audio characteristic exists within the one or more frequency bands of the portion of the audio data.

7. The method of claim 1, wherein applying the acoustic filtering comprises comparing the portion of the audio data to a reference acoustical pattern.

8. The method of claim 7, wherein determining whether or not the issue exists comprises determining whether or not the portion of the audio data matches the reference acoustical pattern.

9. The method of claim 1, wherein the acoustic filtering comprises:
determining one or more operational parameters of the work machine that are coincident with a time at which the portion of the audio data was captured; and
filtering out noise from the portion of the audio data based on the one or more operational parameters.

10. The method of claim 9, wherein the one or more operational parameters comprise one or more of engine speed, pump speed, pump displacement, transmission shifting, valve action, tilt actuation, lift actuation, third function valve actuation, fourth function valve actuation, steering actuation, braking, or ground speed.

11. The method of claim 1, wherein the remedial action comprises outputting a notification of the issue.

12. The method of claim 11, wherein initiating the remedial action comprises determining a component of the work machine that corresponds to the location on the work machine from which the portion of the audio data was captured, and wherein the notification identifies the determined component.

13. The method of claim 12, wherein the component comprises a pin.

14. The method of claim 12, wherein the notification comprises an indication in a cabin of the work machine.

15. The method of claim 1, wherein determining whether or not the issue exists comprises:
determining a component of the work machine that corresponds to the location on the work machine from which the portion of the audio data was captured;
determining whether or not the component was moving at a time at which the portion of the audio data was captured based on sensor data from one or more sensors on the work machine; and
determining whether or not the issue exists based on the acoustic filtering and the determination of whether or not the component was moving at the time.

16. A method comprising using at least one hardware processor in a work machine to, in real time with operation of the work machine:
receive audio data captured by a microphone array mounted on a cabin of the work machine;
apply spatial filtering to the audio data to identify a plurality of portions of the audio data, each of the plurality of portions of the audio data being captured from a different location on the work machine than any other one of the plurality of portions of the audio data, and each location corresponding to a component of the work machine; and
for each of the plurality of portions of the audio data,
apply acoustic filtering to the portion of the audio data,
determine whether or not an issue exists based on the acoustic filtering, and
when determining that the issue exists, output a notification to an operator, the notification identifying the component corresponding to the location from which the portion of the audio data was captured.

17. The method of claim 16, wherein the acoustic filtering comprises a bandpass filter that isolates one or more frequency bands of the portion of the audio data, and wherein determining whether or not the issue exists comprises determining whether or not an audio characteristic exists within the one or more frequency bands of the portion of the audio data.

18. The method of claim 16, wherein applying the acoustic filtering comprises comparing the portion of the audio data to a reference acoustical pattern, and wherein determining whether or not the issue exists comprises determining whether or not the portion of the audio data matches the reference acoustical pattern.

19. The method of claim 16, wherein the acoustic filtering comprises:
determining one or more operational parameters of the work machine that are coincident with a time at which the portion of the audio data was captured; and
filtering out noise from the portion of the audio data based on the one or more operational parameters,
wherein the one or more operational parameters comprise one or more of engine speed, pump speed, pump displacement, transmission shifting, valve action, tilt actuation, lift actuation, third function valve actuation, fourth function valve actuation, steering actuation, braking, or ground speed.

20. A work machine comprising:
a machine body;
a work implement;
one or more acoustic sensors mounted on the work machine; and
a controller configured to, in real time with operation of the work machine,
receive audio data captured by the one or more acoustic sensors,
apply spatial filtering to the audio data to identify one or more portions of the audio data, each of the one or more portions of the audio data being captured from a different location on the work machine than any other one of the one or more portions of the audio data, and each location corresponding to a component of the work machine, and
for each of the one or more portions of the audio data,
apply acoustic filtering to the portion of the audio data,
determine whether or not an issue exists based on the acoustic filtering, and
when determining that the issue exists, output a notification that identifies the component corresponding to the location from which the portion of the audio data was captured.
